(19) United States
(12) Patent Application Publication
(10) Pub. No.: US 2026/0368134 A1
(43) Pub. Date: Nov. 19, 2026

(54) Functional-Domain-Specific Primary Chiplets for Multi-Chiplet Systems

(71) Applicant: Tenstorrent USA, Inc., Austin, TX (US)

(72) Inventors: Zhimin Chen, San Jose, CA (US); Lichen Weng, San Jose, CA (US); Yasuo Ishii, Palo Alto, CA (US)

(21) Appl. No.: 19/680,313

(22) Filed: May 18, 2026

Related U.S. Application Data
(60) Provisional application No. 63/807,880, filed on May 18, 2025.

(51) Int. Cl. G06F 15/80; G06F 21/62; H01Q 1/18

(52) U.S. Cl. CPC G06F 15/8053; G06F 21/62; H01Q 1/18

(57) ABSTRACT

Systems and methods related to domain-specific primary chiplets are disclosed herein. For example, a network of chiplets may include a plurality of chiplets interconnected by a die-to-die interconnect. The plurality of chiplets may collectively support a plurality of functional domains. For each functional domain, the plurality of chiplets may be logically organized as a directed acyclic graph rooted at a primary chiplet designated for that functional domain, such that each non-primary chiplet in the directed acyclic graph forwards domain-specific information toward the primary chiplet of that functional domain. A first primary chiplet designated for a first functional domain may be a different chiplet than a second primary chiplet designated for a second functional domain. Designating a separate primary chiplet for each functional domain of a system-in-package may permit each functional domain to be rooted at the chiplet best suited to host it.

### CROSS REFERENCE TO RELATED APPLICATIONS

This application claims the benefit of U.S. Provisional Patent Application No. 63/807,880, filed May 18, 2025, which is incorporated by reference herein in its entirety for all purposes.

### BACKGROUND

Chiplets are small, specialized integrated circuits designed to function as individual components in a larger system of which they form a part. Chiplets are then integrated together to form a system, such as a System in Package (SiP), which behaves like a traditional monolithic silicon chip, especially from high-level software perspective. Unlike traditional monolithic integrated circuits where all functions are manufactured together on a single piece of silicon, chiplets may be designed, fabricated, and assembled separately. This approach allows for greater flexibility, improved yields, higher cost efficiency, and shorter time to market. While a chiplet-based SiP offers appealing advantages, it also brings new challenges to the SiP development, especially interoperability among various chiplets. There is a growing demand to assure interoperability so that the advantages are indeed redeemed.

The system-level functions supported by a SiP may include functions directed to bringing the SiP from a reset or power-on state to an operational state; functions directed to detection, reporting, and response to faults or errors arising within the SiP; functions directed to enforcement of security policies and protection of security-sensitive operations; functions directed to delivery of interrupts; functions directed to inspection, debug, or testing; functions directed to configuration and ongoing management of the SiP as a coherent system; and functions directed to translation of memory addresses among address spaces of the chiplets. Each such system-level function involves the coordinated participation of two or more chiplets, and each may impose its own requirements on how information is conveyed among the participating chiplets, on which chiplet originates control of the function, and on how the function interfaces with components external to the SiP.

The chiplets within a SiP may differ in their suitability to participate in, or to coordinate, particular system-level functions. A chiplet that includes a hardware root of trust and external attestation interfaces may be well suited to participate in security-related functions; a chiplet coupled to non-volatile boot storage may be well suited to participate in boot-related functions; a chiplet implementing safety-qualified logic may be well suited to participate in safety-related functions; and so on. The capabilities of a given chiplet are determined by its design, and a chiplet sourced from one design team or vendor may have capabilities different from those of a chiplet sourced from another.

In some multi-chiplet designs, the chiplets within a SiP are organized around a designated chiplet that coordinates substantially all system-level functions for the SiP, with that chiplet serving as the central point through which information for each system-level function is aggregated and through which the SiP interfaces externally for those functions. Such an organization implicates considerations relating to the capabilities required of the designated chiplet, the integration of chiplets sourced from heterogeneous design teams or vendors, and the alignment between each system-level function and the chiplet that coordinates it. Multi-chiplet SiPs accordingly raise architectural considerations regarding how the chiplets within a SiP are organized to support the various system-level functions a SiP is to provide.

### SUMMARY

This disclosure relates to domain-specific primary chiplets. A system-in-package (SiP) constructed from a plurality of chiplets supports a number of system-level functions that, taken together, allow the chiplets to operate as a coherent system rather than as isolated dies sharing a substrate. These system-level functions include, by way of example and not limitation, system management, security, boot, functional safety, reliability-availability-serviceability (RAS), interrupt handling, debug and test, address translation, and system time management. Each such function is referred to herein as a "functional domain." A given chiplet may participate in some, all, or none of the functional domains supported by the SiP.

In conventional multi-chiplet designs, the chiplets within a SiP are typically organized around a single hub or master die that owns substantially all system-level functions. Such an arrangement collapses the management hierarchies for system management, security, boot, safety, and other functional domains into a single rooted structure, with one chiplet serving as the root for every domain. While this approach simplifies certain integration tasks, it constrains the SiP integrator's ability to place each domain's root at the chiplet best suited to host it, complicates the use of chiplets sourced from different vendors, and can force a chiplet to assume responsibilities ill-matched to its design.

In embodiments described herein, the chiplets of a SiP are logically organized on a per-functional-domain basis. For each functional domain supported by the SiP, the chiplets participating in that functional domain are organized as a directed acyclic graph (DAG) rooted at a chiplet designated as the primary chiplet for that functional domain. The primary chiplet of a functional domain serves as the root of that functional domain's topology view and as the aggregation point for domain-specific information generated within the SiP. Each non-primary chiplet participating in the functional domain forwards domain-specific information toward the primary chiplet along a directed path defined by the DAG.

Significantly, the primary chiplet designated for one functional domain need not be — and in many embodiments is not — the same chiplet as the primary chiplet designated for another functional domain. The same plurality of chiplets, sharing the same physical interconnect, may therefore present a different rooted topology for each functional domain it supports. A first chiplet may serve as the primary chiplet for a first functional domain while a second, different chiplet serves as the primary chiplet for a second functional domain; a single chiplet may serve as the primary chiplet for two or more functional domains; or a chiplet may participate in one or more functional domains without serving as the primary chiplet for any of them. By way of illustration, in one example SiP a first chiplet hosting general-purpose processing cores serves as the primary chiplet for the system management domain, while a second chiplet hosting input/output functionality serves as the primary chiplet for the security domain.

In some embodiments, each chiplet participating in a given functional domain may implement a domain-local aggregation entity configured to combine domain-specific information generated locally at that chiplet with domain-specific information received from any downstream chiplet in the DAG for that functional domain, and to forward the combined information to an immediately upstream chiplet in the DAG. This aggregation pattern may be instantiated independently for each functional domain, such that a single chiplet may host multiple aggregation entities — one per functional domain in which it participates — each operating along the DAG defined for its respective functional domain.

In some embodiments, the per-domain topology of the SiP may be established at packaging time and conveyed to software executing on the SiP through a device configuration data structure. The device configuration data structure may specify, for each functional domain, an identification of the primary chiplet for that functional domain and a description of the DAG rooted at that primary chiplet, including, for each non-primary chiplet participating in the functional domain, an identification of the immediately upstream chiplet to which domain-specific information is forwarded. Because the topology is fixed at packaging and declared in the device configuration data structure, runtime discovery of the per-domain topologies may not be required; software may consult the device configuration data structure to determine, for any functional domain, the primary chiplet, the participating chiplets, and the routing of domain-specific information among them.

In some embodiments, domain-specific information for each functional domain may be conveyed among the chiplets along a domain-specific channel distinct from the channels used for other functional domains. The primary chiplet of a functional domain may, in some embodiments, communicate aggregated domain-specific information for that functional domain to a controller external to the SiP, such as a baseboard management controller for the boot or system management domain or a safety microcontroller unit for the functional safety domain. In embodiments in which more than one functional domain communicates externally, the external communication paths for the respective primary chiplets may be independent of one another, such that no single chiplet of the SiP is required to serve as a common point of egress for all functional domains.

Decoupling the primary role on a per-functional-domain basis can permit a SiP integrator to place each functional domain's root at the chiplet best suited to host it — for example, locating a security domain's primary at a chiplet that implements a hardware root of trust, locating a boot domain's primary at a chiplet coupled to non-volatile boot storage, and locating a functional safety domain's primary at a chiplet implementing safety-qualified logic — without requiring any one chiplet to host the root of every functional domain. This in turn may facilitate the assembly of SiPs from chiplets sourced from different vendors, since no single chiplet need be capable of, or responsible for, every system-level function. Establishing the per-domain topologies at packaging time and conveying them to software through a device configuration data structure may further obviate the need for runtime topology discovery, allowing software to determine the primary chiplet, participating chiplets, and information flow for any functional domain by consulting the device configuration data structure. The use of independent external communication paths for different functional domains' primary chiplets may also permit, for example, boot and management information to be conveyed to a baseboard management controller while functional safety information is conveyed to a separate safety microcontroller unit, without either path traversing the other functional domain's primary chiplet.

In specific embodiments of the invention, a network of chiplets is provided. The network comprises a plurality of chiplets interconnected by a die-to-die interconnect, the plurality of chiplets collectively supporting a plurality of functional domains, the functional domains comprising at least two of: a system management domain, a security domain, a boot domain, a functional safety domain, a reliability-availability-serviceability domain, an interrupt domain, a debug or test domain, an address translation domain, and a system time management domain. For each functional domain of the plurality of functional domains, the plurality of chiplets is logically organized as a directed acyclic graph rooted at a primary chiplet designated for that functional domain, such that each non-primary chiplet in the directed acyclic graph forwards domain-specific information toward the primary chiplet of that functional domain. A first primary chiplet designated for a first functional domain of the plurality of functional domains is a different chiplet of the plurality of chiplets than a second primary chiplet designated for a second functional domain of the plurality of functional domains.

In specific embodiments of the invention, a system-in-package is provided. The system-in-package comprises a plurality of chiplets interconnected by a die-to-die interconnect and supporting a plurality of functional domains; and a configuration memory storing a device configuration data structure, the device configuration data structure specifying, for each functional domain of the plurality of functional domains: an identification of a primary chiplet, from the plurality of chiplets, for that functional domain; and a directed acyclic graph rooted at the primary chiplet and describing, for each non-primary chiplet participating in that functional domain, one or more immediately upstream chiplet to which domain-specific information is forwarded. The device configuration data structure identifies different primary chiplets for at least two different functional domains of the plurality of functional domains.

In specific embodiments of the invention, a system-in-package is provided. The system-in-package comprises: a first primary chiplet for a first functional domain and a second primary chiplet for a second functional domain. The second primary chiplet is different than the first primary chiplet and the second functional domain is different than the first functional domain. The system-in-package also comprises a third chiplet configured to send first information specific to the first functional domain to the first primary chiplet and to send second information specific to the second functional domain to the second primary chiplet.

### BRIEF DESCRIPTION OF THE DRAWINGS

The accompanying drawings illustrate various embodiments of systems, methods, and embodiments of various other aspects of the disclosure. A person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 provides an example of a layered model of a chiplet architecture in accordance with specific embodiments of the inventions disclosed herein.

FIG. 2 illustrates an example of a chiplet network with a base chiplet in accordance with specific embodiments of the inventions disclosed herein.

FIG. 3 illustrates example chiplet clusters with application channels in accordance with specific embodiments of the inventions disclosed herein.

FIG. 4 illustrates a topology view of a system management functional domain and a topology view of a security functional domain of the same chiplet cluster in accordance with specific embodiments of the inventions disclosed herein.

FIG. 5 illustrates a topology view of a chiplet network in which a single chiplet serves as the primary chiplet for more than one functional domain in accordance with specific embodiments of the inventions disclosed herein.

FIG. 6 illustrates a network of chiplets collectively supporting a plurality of functional domains in accordance with specific embodiments of the inventions disclosed herein.

FIG. 7 illustrates a network of chiplets collectively supporting a plurality of functional domains where not every chiplet participates in every domain in accordance with specific embodiments of the inventions disclosed herein.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Different systems and methods for domain-specific primary chiplets in accordance with the summary above are described in detail in this disclosure. The methods and systems disclosed in this section are nonlimiting embodiments of the invention, are provided for explanatory purposes only, and should not be used to constrict the full scope of the invention. It is to be understood that the disclosed embodiments may or may not overlap with each other. Thus, part of one embodiment, or specific embodiments thereof, may or may not fall within the ambit of another, or specific embodiments thereof, and vice versa. Different embodiments from different aspects may be combined or practiced separately. Many different combinations and sub-combinations of the representative embodiments shown within the broad framework of this invention, that may be apparent to those skilled in the art but not explicitly shown or described, should not be construed as precluded.

In embodiments described herein, the chiplets of a system-in-package (SiP) are logically organized on a per-functional-domain basis. For each functional domain supported by the SiP, the chiplets participating in that functional domain are organized as a directed acyclic graph (DAG) rooted at a chiplet designated as the primary chiplet for that functional domain. The primary chiplet of a functional domain serves as the root of that functional domain's topology view and as the aggregation point for domain-specific information generated within the SiP. Each non-primary chiplet participating in the functional domain forwards domain-specific information toward the primary chiplet along a directed path defined by the DAG.

As used herein, a "functional domain" refers to a system-level function supported by a SiP that involves coordinated participation by two or more chiplets of the SiP. Functional domains include, by way of example and not limitation, a system management domain directed to configuration and control of the SiP as a coherent system, a security domain directed to enforcement of security policies and protection of security-sensitive operations across the SiP, a boot domain directed to bringing the SiP from a reset or power-on state to an operational state, a functional safety domain directed to detection, reporting, and response to faults that may impact safe operation of the SiP, a reliability-availability-serviceability (RAS) domain directed to detection and reporting of errors affecting reliability of the SiP, an interrupt domain directed to delivery of interrupts among the chiplets of the SiP, a debug or test domain directed to inspection or testing of the SiP, an address translation domain directed to translation of memory addresses among address spaces of the chiplets of the SiP, and a system time management domain directed to maintaining and distributing a coherent notion of time across the chiplets of a SiP. A given chiplet may participate in some, all, or none of the functional domains supported by the SiP. The functional domains supported by a given SiP may be determined by the SiP's design and need not include every functional domain enumerated herein.

As used herein, a "primary chiplet" of a functional domain refers to the chiplet of a SiP that is designated as the root of the directed acyclic graph defined for that functional domain, and that serves as the aggregation point for domain-specific information generated within the SiP for that functional domain. A primary chiplet of a functional domain receives, directly or indirectly through one or more intermediate chiplets, domain-specific information forwarded from each non-primary chiplet of the SiP that participates in that functional domain. A given chiplet of a SiP may serve as the primary chiplet for one functional domain, for more than one functional domain, or for no functional domain. The primary chiplet for one functional domain may be, but need not be, the same chiplet as the primary chiplet for another functional domain.

As used herein, "domain-specific information" refers to information generated, conveyed, or processed by a chiplet in connection with the chiplet's participation in a particular functional domain. Domain-specific information for a given functional domain may include, by way of example and not limitation, status reports, fault indications, interrupt notifications, configuration data, requests, responses, control messages, and aggregated information received from other chiplets participating in the functional domain. Domain-specific information for one functional domain may be logically distinct from domain-specific information for another functional domain, even where the same chiplet generates or processes information for both functional domains.

Domain-specific information for a functional domain may be conveyed in either direction along an edge of the DAG defined for that functional domain. By way of example and not limitation, domain-specific information may include information conveyed from a non-primary chiplet toward the primary chiplet of the functional domain (e.g., status reports, error notifications, interrupt notifications, attestation responses, configuration responses, or aggregated information from one or more downstream chiplets) and information conveyed from the primary chiplet toward one or more non-primary chiplets of the functional domain (e.g., configuration commands, control messages, boot or reset sequencing commands, debug or test commands, attestation challenges, security policy updates, address-translation updates, time-distribution messages, or interrupt-related commands). The same DAG may carry both upstream and downstream information for a given functional domain, with the direction of any particular message determined by the requirements of the functional domain and the nature of the information being conveyed.

As used herein, a "directed acyclic graph" or "DAG" describing the organization of chiplets for a functional domain refers to a graph in which each node represents a chiplet of the SiP that participates in the functional domain, and each directed edge represents an authority relationship defining the management hierarchy for the functional domain, with the edge directed from a chiplet of lower or equal management authority toward a chiplet of higher management authority. The direction of a directed edge in a DAG for a functional domain defines the management hierarchy of that functional domain and does not require that information flow exclusively in the direction of the edge; information may flow in the direction of the edge, in the opposite direction, or in both directions between the chiplets connected by the edge, depending on the requirements of the functional domain and the nature of the information exchanged, with the property that no sequence of directed edges forms a cycle. A DAG for a functional domain is rooted at the primary chiplet of that functional domain. For a given non-primary chiplet in a DAG, an "immediately upstream chiplet" refers to a chiplet that is the destination of a directed edge originating at the given chiplet, and a "downstream chiplet" refers to a chiplet from which a directed path leads to the given chiplet. A DAG for a functional domain may, in some embodiments, be further constrained such that each non-primary chiplet has exactly one immediately upstream chiplet, in which case the DAG is a directed tree.

References herein to "an immediately upstream chiplet" of a given non-primary chiplet are non-limiting and encompass embodiments in which the given non-primary chiplet has a single immediately upstream chiplet as well as embodiments in which the given non-primary chiplet has two or more immediately upstream chiplets in the DAG defined for the functional domain. Where a non-primary chiplet has two or more immediately upstream chiplets, the non-primary chiplet may forward domain-specific information for the functional domain to each of the two or more immediately upstream chiplets, to a selected subset of the two or more immediately upstream chiplets, or to a selected one of the two or more immediately upstream chiplets, depending on the requirements of the functional domain and the configuration of the SiP. A DAG in which each non-primary chiplet has exactly one immediately upstream chiplet is a directed tree and is one example, and not the only example, of a DAG suitable for a functional domain.

The architectures described herein accommodate SiPs assembled from chiplets sourced from a single vendor and SiPs assembled from chiplets sourced from multiple vendors. Because the primary role for any given functional domain may be allocated to the chiplet best suited to host it, no single chiplet — and no single vendor — need be capable of, or responsible for, hosting the root of every functional domain.

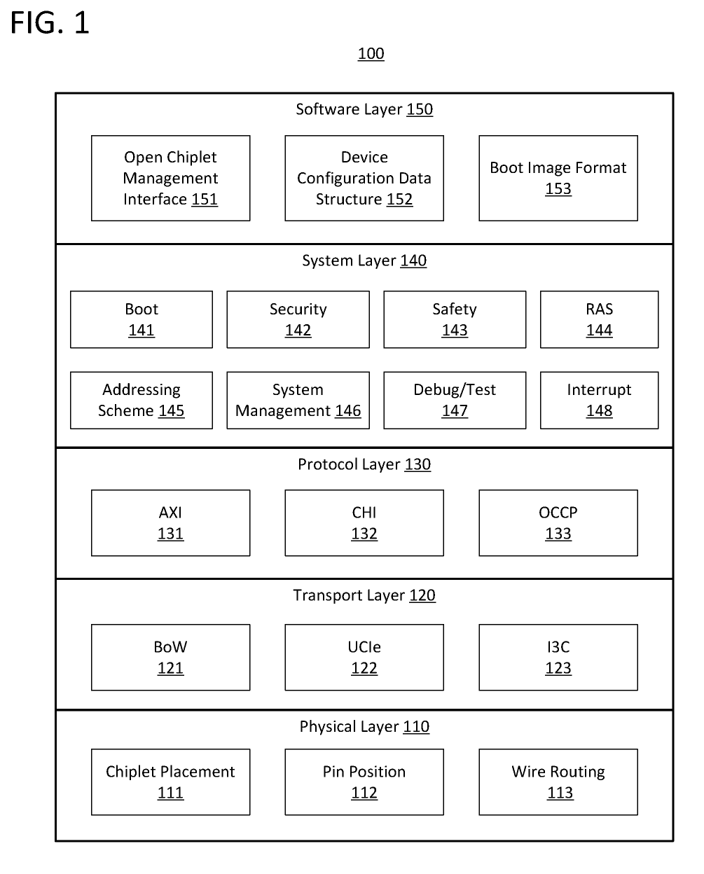

FIG. 1 illustrates layered model 100 of a chiplet architecture in accordance with specific embodiments of the inventions disclosed herein. In the illustrated embodiment, the architecture is organized into physical layer 110, transport layer 120, protocol layer 130, system layer 140, and software layer 150. Layered model 100 is a conceptual representation showing that chiplet interoperability can be addressed across multiple layers, rather than only at a die-to-die signaling level.

Physical layer 110 may define physical integration aspects of the chiplet system, such as chiplet placement 111, pin position 112, and wire routing 113. Physical layer 110 may represent package-level and physical-implementation considerations used to physically realize communication among chiplets.

Transport layer 120 may provide mechanisms for transferring data between chiplets. In the illustrated example, transport layer 120 includes Bunch of Wires (BoW) 121, Universal Chip Interconnect Express (UCIe) 122, and Improved Inter-Integrated Circuit (I3C) 123. These transport mechanisms are shown as examples of lower-layer communication technologies by which information may be conveyed among chiplets.

Protocol layer 130 may define mechanisms for interpreting data, packets, messages, transactions, or other communication units and for mapping such communications to local fabrics, higher-level system functions, or buses. In the illustrated example, protocol layer 130 includes AXI 131, CHI 132, and Open Chiplet Configuration Protocol (OCCP) 133. OCCP may be a boot and system management protocol. These protocol examples are illustrative, and other protocol arrangements may be used in other embodiments.

System layer 140 may define system-level functionality distributed across multiple chiplets. In the illustrated example, system layer 140 includes Boot 141, Security 142, Safety 143, RAS 144, Addressing Scheme 145, System Management 146, Debug/Test 147, and Interrupt 148. These system-layer functions represent architectural functions that enable chiplets to operate together as a coordinated and coherent system. Each such system-layer function may correspond to a functional domain of the chiplet system, and, in some embodiments, the chiplets participating in a given functional domain may be logically organized as a directed acyclic graph rooted at a primary chiplet designated for that functional domain. The primary chiplet designated for one functional domain may not be the same chiplet as the primary chiplet designated for another functional domain, such that the same plurality of chiplets may present a different rooted topology at system layer 140 for each functional domain the chiplets support.

Software layer 150 may define software-visible interfaces and data structures used to configure, manage, and support operation of the chiplet system. Software layer 150 may define standard device configuration data structures and software interfaces. In the illustrated example, software layer 150 includes Open Chiplet Management Interface 151, Device Configuration Data Structure 152, and Boot Image Format 153. In some embodiments, Device Configuration Data Structure 152 may specify, for each functional domain supported at system layer 140, an identification of the primary chiplet for that functional domain and a description of the directed acyclic graph rooted at that primary chiplet, thereby exposing the per-domain topology of the chiplet system to software without runtime topology discovery.

In some embodiments of the present disclosure, one or more architectural inter-chiplet channels are defined at system layer 140. For example, an architectural channel may correspond to a system-layer function or functional domain such as boot, system management, security, interrupt handling, debug/test, or safety. The architectural channel may thus be maintained as a system-layer construct independently of any particular lower-layer implementation. A selected implementation of a given architectural channel may be realized through lower layers of the stack, such as the protocol layer 130, transport layer 120, and physical layer 110. Thus, traffic associated with an architectural channel may be mapped to a selected protocol, a selected transport mechanism, and selected physical-layer communication resources. Because the channel is maintained at system layer 140, the identity of the channel may remain unchanged even when its lower-layer realization changes. In some embodiments, an architectural channel for a given functional domain may convey domain-specific information among the chiplets participating in that functional domain along the DAG defined for the functional domain, with non-primary chiplets forwarding domain-specific information toward the primary chiplet of the functional domain. A given chiplet of the system may host one or more domain-local aggregation entities, each corresponding to a functional domain in which the chiplet participates and each operating along the architectural channel and directed acyclic graph defined for its respective functional domain. Architectural channels for different functional domains may be logically distinct, even where they share an underlying lower-layer realization, such that the per-domain topologies remain independent of one another at system layer 140.

The layered arrangement shown in FIG. 1 is illustrative and non-limiting. In various embodiments, one or more layers may be combined, subdivided, omitted, supplemented, or otherwise implemented differently. Likewise, the particular examples shown within each layer are illustrative and do not limit the scope of the disclosed embodiments.

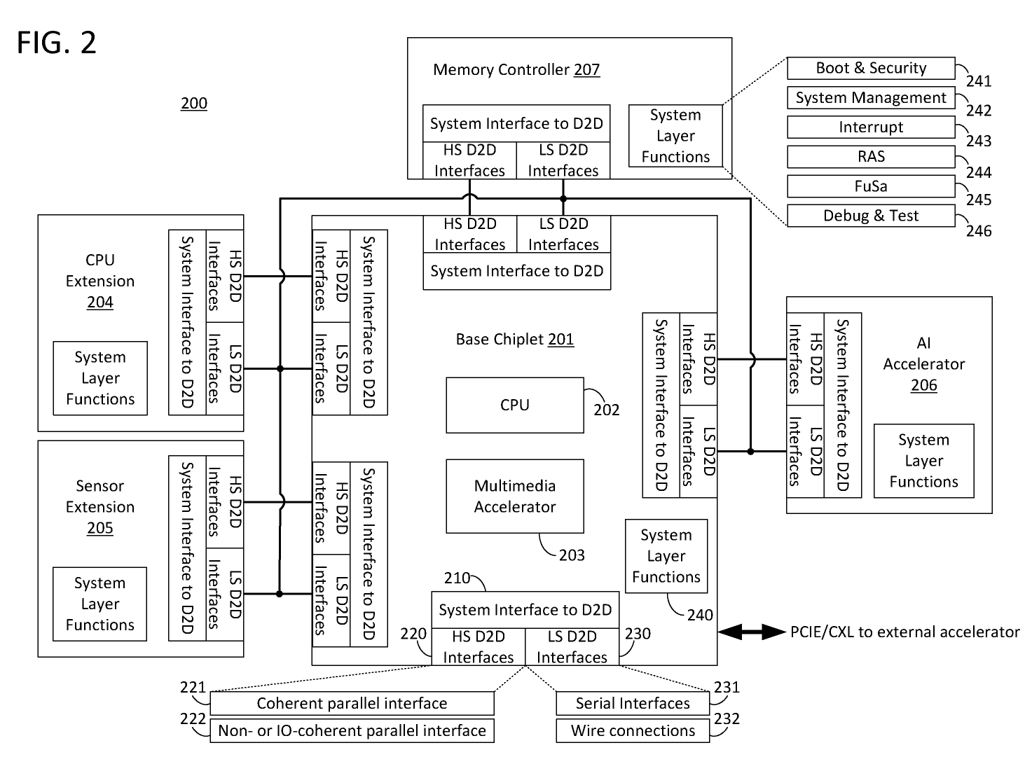

FIG. 2 illustrates an example of chiplet network 200 with base chiplet 201 in accordance with specific embodiments of the inventions disclosed herein. The arrangement of chiplets shown in FIG. 2 is illustrative of an extended chiplet integration in which a base chiplet is coupled to one or more extension chiplets that provide additional compute, memory, sensing, or acceleration functionality. In the illustrated embodiment, chiplet network 200 includes base chiplet 201 having CPU 202 and multimedia accelerator 203. Base chiplet 201 is coupled to additional chiplets, such as CPU extension 204, sensor extension 205, AI accelerator 206, and memory controller 207. In the illustrated example, base chiplet 201 is also shown as being connectable to an external accelerator through a PCIe/CXL connection.

One or more chiplets may include a System Interface to die-to-die (D2D) 210 and corresponding high-speed (HS) D2D Interfaces 220 and low-speed (LS) D2D Interfaces 230. In the illustrated example, the System Interface to D2D 210 may serve as an interface between local functional circuitry of a chiplet and die-to-die communication resources used to communicate with other chiplets. The HS D2D Interfaces 220 may correspond to higher-bandwidth chiplet-to-chiplet communication resources, while the LS D2D Interfaces 230 may correspond to lower-bandwidth, control-oriented, or out-of-band communication resources. By way of example, HS D2D Interfaces 220 may be associated with a coherent parallel interface 221 or a non-coherent or IO-coherent parallel interface 222, while the LS D2D Interfaces 230 may be associated with serial interfaces 231 or wire connections 232.

In specific embodiments, System Interface to D2D 230 may include or cooperate with a protocol bridge and attribute extension. The protocol bridge and attribute extension may support functions such as address translation and remap, secure communication, functional safety (FuSa) communication, and RAS communication. In this manner, the System Interface to D2D 210 can provide adaptation between local chiplet functions and one or more selected die-to-die communication mechanisms, while also carrying channel-related attributes or domain-specific information used for inter-chiplet communication. In some embodiments, the domain-specific information conveyed through System Interface to D2D 210 includes information for one or more functional domains in which the chiplet participates, such information being conveyed toward the primary chiplet designated for the corresponding functional domain along the directed acyclic graph defined for that functional domain.

In the illustrated embodiment, one or more chiplets further include system layer functions 240. Example system layer functions may include Boot and Security 241, System Management 242, Interrupt 243, RAS 244, FuSa 245, and Debug and Test 246. The system-level functionality of a chiplet may be architecturally distinct from the lower-layer communication resources used to carry inter-chiplet traffic. In some embodiments of the present disclosure, one or more of the functions shown in FIG. 2 may be implemented as respective architectural channels at a system layer. Each such system layer function may correspond to a functional domain having its own primary chiplet within chiplet network 200, and a given chiplet of chiplet network 200 may host one or more domain-local aggregation entities, each corresponding to a functional domain in which the chiplet participates. The domain-local aggregation entities of a given chiplet may operate independently of one another along the respective directed acyclic graphs defined for their functional domains.

Although FIG. 2 illustrates an extended integration using a base chiplet 201, the disclosed subject matter is not limited to that organization. In other embodiments, a chiplet network may use a centralized chiplet or hub chiplet that primarily provides interconnection among chiplets, rather than serving as a base chiplet to which extension chiplets are attached. In still other embodiments, a chiplet network may use a distributed topology without a hub, in which chiplets communicate through peer-to-peer or otherwise distributed interconnections and each participating chiplet includes corresponding system-interface-to-D2D functionality and system-layer functions. Thus, the particular physical organization of chiplets may vary while still using system-layer architectural channels and lower-layer channel mappings as described herein. The per-functional-domain organization described herein, in which each functional domain is rooted at a primary chiplet designated for that functional domain, is likewise applicable to extended-integration arrangements such as that of FIG. 2, to centralized arrangements employing a hub chiplet, and to distributed arrangements without a hub.

Accordingly, FIG. 2 should be understood as one non-limiting example of a chiplet network in which chiplet functions are partitioned across multiple chiplets, system-layer functions are maintained separately from lower-layer D2D communication resources, and architectural channels may be mapped onto different physical communication resources within the chiplet network. The number, type, and placement of chiplets, as well as the particular organization of the System Interface to D2D, HS D2D Interfaces, LS D2D Interfaces, protocol bridges, and system layer functions, may vary in different embodiments.

In hierarchical system architectures, where chiplets can assume different roles, some chiplets may act as primaries while other chiplets may act as secondaries for that functional domain. A primary chiplet serves as the main control element for a specific functional domain. For each functional domain, there may be a single primary chiplet in a package, while other chiplets operate as secondaries. Different functional domains may have different requirements for the primary chiplet. For example, a boot primary chiplet may have the requirement of booting first, having access to necessary peripheral interfaces, and booting up the rest of the SiP. As another example, the system management primary chiplet may oversee the system management tasks for the whole SiP and may interface to the system software. In specific embodiments, a single chiplet may serve as the primary chiplet across all functional domains. In specific embodiments, a SiP integrator may choose to designate different chiplets as the primary for distinct functional domains, for example, assigning separate primary chiplets for Security/Boot/Debug/DFT (Design for Test) and for System Management/System Time Management/RAS/FuSa. In the chiplet network 200 of FIG. 2, by way of non-limiting example, base chiplet 201 may be designated as the primary chiplet for one or more functional domains, while one or more of CPU extension 204, sensor extension 205, AI accelerator 206, and memory controller 207 may be designated as the primary chiplet for one or more other functional domains; the primary chiplet for any given functional domain may be selected by the SiP integrator based on the suitability of each chiplet for the functional domain in question. In further embodiments, a chiplet of chiplet network 200 may participate in one or more functional domains without being designated as the primary chiplet for any functional domain. A chiplet intended to serve as the central controller of the SiP may be designed to support the primary functions of all relevant domains. Chiplets may be designed with secondary capabilities and interfaces to support multi-instantiation and to provide the SiP integrator with the flexibility to designate the appropriate primary for each functional domain.

In specific embodiments, chiplets in a package and their connections may form a Directed Acyclic Graph. Each node in the graph may correspond to a chiplet. The edges may indicate logical relationships between chiplets for purposes of a given functional domain, which may be supported by underlying physical connections between chiplets. The direction of the edges may not define uni- or bi-directional traffic; instead, the direction may specify the management hierarchy for the functional domain to which the DAG corresponds. Following the direction of a directed edge, the graph moves from an upstream chiplet to a downstream chiplet. The upstream chiplet may be at the same or higher management level than the downstream. The topology may include roots, leafs, and non-leafs organized upstream and downstream relative to each other. Chiplets that are upstream of a given chiplet may be chiplets that have a directed path to that chiplet. Chiplets that are downstream of a given chiplet may be chiplets that can be reached from that chiplet via a directed path. The topology root of a directed acyclic graph for a functional domain is the primary chiplet for that functional domain. A leaf may be an end chiplet with no downstream chiplet. A non-leaf may be an intermediate chiplet with at least one upstream chiplet and one downstream chiplet. The topology view is domain specific, such that the same plurality of chiplets may form a different Directed Acyclic Graph for each functional domain the chiplets support, with the primary chiplet for one functional domain potentially being a different chiplet than the primary chiplet for another functional domain. The primary chiplet of a functional domain sits at the root of that functional domain’s topology view. Information about the chiplet topology configuration may be provided to software through a data structure, which may, in some embodiments, specify, for each functional domain, an identification of the primary chiplet for that functional domain and a description of the Directed Acyclic Graph rooted at that primary chiplet. The SiP integrator may provide the data structure. In specific embodiments, topology may be fixed after packaging such that no discovery is required during boot time or run time.

The chiplets of a SiP may assume different roles with respect to the various functional domains supported by the SiP. A given chiplet may serve as a primary chiplet, as a non-primary chiplet, or as a primary chiplet for some functional domains and a non-primary chiplet for other functional domains. The primary chiplet of a functional domain serves as the main control element for that functional domain and as the root of the directed acyclic graph defined for that functional domain. For each functional domain supported by a SiP, the SiP includes a chiplet of the SiP designated as the primary chiplet for that functional domain, with the remaining chiplets that participate in the functional domain operating as non-primary chiplets for that functional domain.

Different functional domains may impose different requirements on the chiplet that serves as the primary chiplet for the functional domain, reflecting the differing nature of the functions involved. The following examples describe roles that a primary chiplet may perform for various functional domains in some embodiments, by way of example and not limitation.

In some embodiments, the primary chiplet for the boot functional domain is configured to boot first among the chiplets of the SiP, has access to peripheral interfaces appropriate for accessing boot information, and is responsible for bringing up the remaining chiplets of the SiP. In some embodiments, the primary chiplet for the system management functional domain is configured to oversee system management tasks for the SiP as a whole and to interface with system software executing on the SiP. In some embodiments, the primary chiplet for the system time management functional domain holds a reference time for the SiP and provides time information to other chiplets of the SiP.

In some embodiments, the primary chiplet for the security functional domain serves as a hardware root of trust for the SiP and is configured to verify the integrity and authenticity of the SiP. In some embodiments, the primary chiplet for the debug functional domain interfaces with an external debugger and routes debug traffic to other chiplets of the SiP, and the primary chiplet for the design-for-test functional domain interfaces with an external tester and routes test traffic to other chiplets of the SiP. In some embodiments, the debug functional domain and the design-for-test functional domain are implemented as a combined debug or test functional domain having a single primary chiplet.

In some embodiments, the primary chiplet for the RAS functional domain serves as the root of an error aggregation hierarchy for that functional domain, receiving error information aggregated from the other chiplets that participate in the RAS functional domain. In some embodiments, the primary chiplet for the functional safety functional domain similarly serves as the root of an error aggregation hierarchy for that functional domain, receiving safety information aggregated from the other chiplets that participate in the functional safety functional domain.

In some embodiments, the primary chiplet for the boot functional domain is configured to issue boot-sequencing commands toward one or more non-primary chiplets along the DAG defined for the boot functional domain, the boot-sequencing commands directing the non-primary chiplets through stages of bringing the SiP from a reset or power-on state to an operational state. In some embodiments, the primary chiplet for the system management functional domain is configured to issue configuration commands toward one or more non-primary chiplets along the DAG defined for the system management functional domain, the configuration commands directing the non-primary chiplets to apply configuration values received from system software. In some embodiments, the primary chiplet for the security functional domain is configured to issue attestation challenges toward one or more non-primary chiplets along the DAG defined for the security functional domain and to receive attestation responses from the one or more non-primary chiplets along the same DAG. In some embodiments, the primary chiplet for the debug or test functional domain is configured to issue debug or test commands toward one or more non-primary chiplets along the DAG defined for that functional domain and to receive debug or test responses from the one or more non-primary chiplets along the same DAG. The foregoing examples are non-limiting; any primary chiplet may, in various embodiments, issue domain-specific information toward one or more non-primary chiplets along the DAG defined for the corresponding functional domain.

In some embodiments, the interrupt functional domain is organized in a manner that does not designate any single chiplet as a primary chiplet for the interrupt functional domain in the manner described above for other functional domains.

In some embodiments, a single chiplet of a SiP serves as the primary chiplet for substantially all of the functional domains supported by the SiP. By way of non-limiting example, base chiplet 201 may serve as the primary chiplet for substantially all of the functional domains supported by chiplet network 200. In other embodiments, a SiP integrator designates different chiplets as the primary chiplet for different functional domains supported by the SiP. By way of non-limiting example, a first chiplet of a SiP may be designated as the primary chiplet for the security functional domain, the boot functional domain, the debug functional domain, and the design-for-test functional domain, while a second chiplet of the SiP, different from the first chiplet, is designated as the primary chiplet for the system management functional domain, the system time management functional domain, the RAS functional domain, and the functional safety functional domain. Other groupings of functional domains across primary chiplets are also contemplated.

A chiplet that is intended to serve as a central controller of a SiP may, in some embodiments, be designed to support the role of primary chiplet for substantially all of the functional domains relevant to the SiP. In some embodiments, each chiplet of a SiP that is to participate in a given functional domain is designed with capabilities and interfaces sufficient to operate as a non-primary chiplet for that functional domain, such that a SiP integrator may flexibly designate, for each functional domain supported by the SiP, the chiplet of the SiP that is to serve as the primary chiplet for that functional domain. Designing chiplets with such non-primary capabilities and interfaces may, in some embodiments, support multi-instantiation of chiplets within a SiP and may permit a SiP integrator to designate the primary chiplet for each functional domain based on the capabilities of the chiplets and the requirements of the SiP.

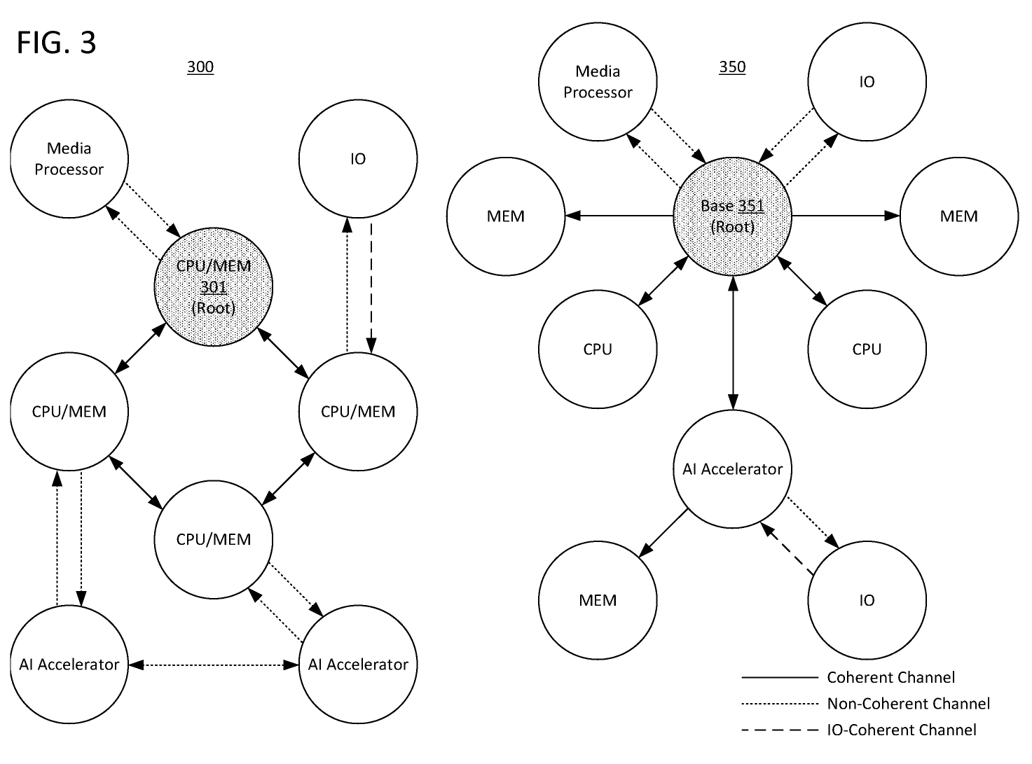

FIG. 3 illustrates example chiplet clusters 300 and 350 with application channels in accordance with specific embodiments of the inventions disclosed herein. A chiplet network of a SiP may support multiple logical channels over the same physical interconnect resources. The logical channels may include application channels, which carry data-plane traffic among compute, memory, accelerator, and I/O chiplets, and non-application channels, which carry information for system-level functions such as boot, system management, security, interrupts, RAS, debug, test, and functional safety. A given logical channel may be considered an architectural construct that is not necessarily equivalent to a physical connection; logical channels may be merged onto a common physical connection, or split across multiple physical connections, with each physical connection operating according to its own bus protocol and transport mechanism, examples of which include AXI, CHI, UCIe, and BoW. In the illustrated examples, application channels are shown as coherent channels (solid lines), non-coherent channels (dotted lines), and IO-coherent channels (dashed lines). Different communication relationships among chiplets within a cluster may use different logical channel types; the chiplet network supports such heterogeneous channel arrangements.

Cluster 300 illustrates a chiplet network in which a plurality of CPU/MEM chiplets are arranged as a compute-oriented cluster, with CPU/MEM chiplet 301 acting as a root chiplet of the application-channel topology view for the cluster, and with peripheral and accelerator chiplets, such as a Media Processor, an IO chiplet, and AI Accelerator chiplets, attached to the cluster using application channels of various types. Cluster 350 illustrates a heterogeneous chiplet network including base chiplet 351 at the center, with base chiplet 351 acting as a root or anchor chiplet of the application-channel topology view of the cluster and being coupled to compute, memory, accelerator, and I/O chiplets using application channels of various types.

The chiplet networks illustrated in clusters 300 and 350 may concurrently support non-application channels for system-level functions, in addition to the application channels shown in FIG. 3. In some embodiments of the present disclosure, each non-application channel corresponds to a functional domain of the SiP, and chiplets participating in a given functional domain are logically organized as a directed acyclic graph rooted at a primary chiplet designated for that functional domain. Domain-specific information for the functional domain is conveyed along the non-application channel for that functional domain, with non-primary chiplets forwarding domain-specific information toward the primary chiplet along the directed acyclic graph.

The directed acyclic graph defined for any given functional domain is independent of the application-channel topology view illustrated in FIG. 3, and the directed acyclic graph defined for one functional domain is independent of the directed acyclic graph defined for any other functional domain. Accordingly, the chiplet that acts as the root of the application-channel topology view of cluster 300 or cluster 350 need not be, and in some embodiments is not, the primary chiplet for any given functional domain supported by the chiplet network. The base chiplet of cluster 350 may, in some embodiments, additionally serve as the primary chiplet for one or more functional domains supported by the chiplet network — for example, the system management domain, the security domain, or both — such that the base chiplet acts as both the root of the application-channel topology view shown in FIG. 3 and the primary chiplet for one or more functional domains. In other embodiments, the primary chiplet for one or more functional domains supported by the chiplet network is a different chiplet than the base chiplet, and the primary chiplet designated for one functional domain is a different chiplet than the primary chiplet designated for another functional domain.

The arrangements shown in clusters 300 and 350 are illustrative and non-limiting. Different embodiments may use different numbers of chiplets, different root chiplets, different types of chiplets, different mixes of channels, and different per-functional-domain primary chiplet designations. The chiplet network may simultaneously support channels of different abstraction layers, including application channels and non-application channels, and may simultaneously support directed acyclic graphs defined for any number of functional domains.

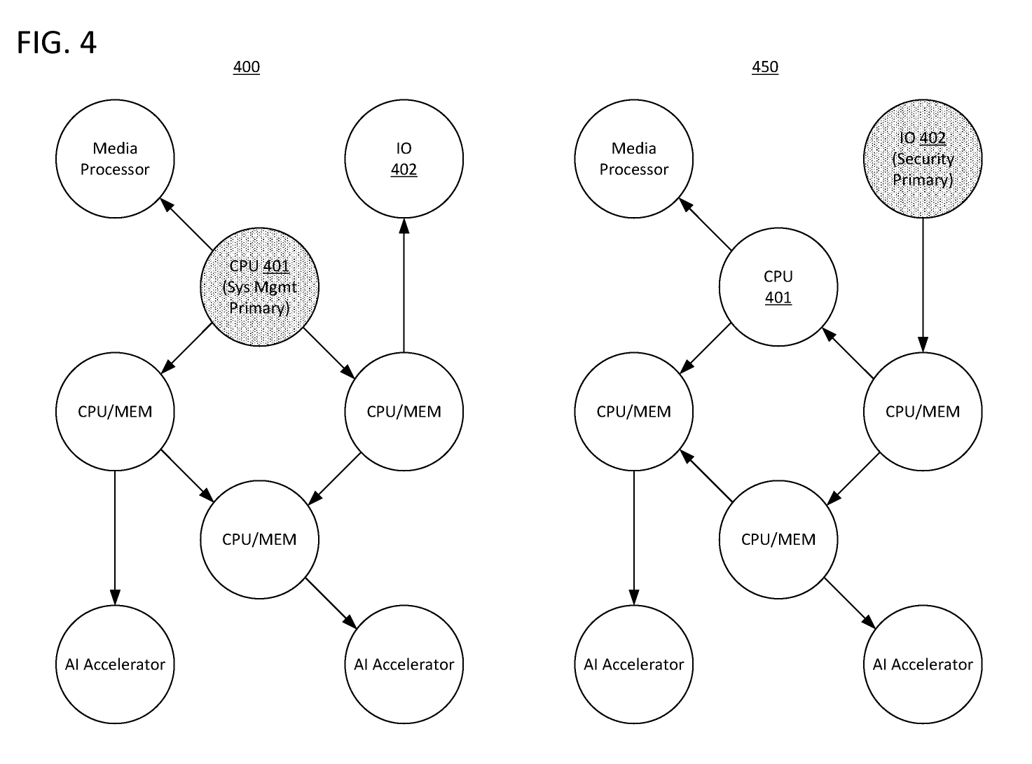

FIG. 4 illustrates topology view 400 of a system management functional domain and topology view 450 of a security functional domain of the same chiplet cluster in accordance with specific embodiments of the inventions disclosed herein. Topology views 400 and 450 are illustrative of two functional-domain topology views of a single chiplet network, showing how the same plurality of chiplets within a SiP may be logically organized as a different rooted directed acyclic graph for each of two different functional domains. The chiplet network represented in FIG. 4 includes a CPU chiplet 401, an IO chiplet 402, a Media Processor chiplet, three CPU/MEM chiplets, and two AI Accelerator chiplets, the same chiplets being represented in both topology view 400 and topology view 450. The connectivity among the chiplets at a physical-interconnect level is shared between the two views; the directed acyclic graphs differ because the system management functional domain and the security functional domain have different primary chiplets and accordingly different management hierarchies. The direction of the arrows may not define uni- or bi-directional traffic or physical wires; instead, the direction may specify the management hierarchy.

In topology view 400, CPU chiplet 401 is the primary chiplet designated for the system management functional domain. CPU chiplet 401 thus serves as the root of the directed acyclic graph defined for the system management functional domain, and as the aggregation point for system management information generated within the chiplet network. Each non-primary (e.g., secondary) chiplet that participates in the system management functional domain forwards system management information toward CPU chiplet 401 along a directed path defined by the directed acyclic graph, with such information being forwarded directly from a chiplet to its immediately upstream chiplet in the graph or, where the immediately upstream chiplet is not the primary chiplet, being aggregated by the immediately upstream chiplet with system management information of that chiplet and forwarded further upstream toward CPU chiplet 401. By way of non-limiting example, in topology view 400 the Media Processor chiplet, the three CPU/MEM chiplets, the IO chiplet 402, and the two AI Accelerator chiplets each forward system management information toward CPU chiplet 401 along the directed acyclic graph illustrated in topology view 400, with one or more intermediate chiplets aggregating system management information received from downstream chiplets with system management information generated locally before forwarding the aggregated information further upstream.

In topology view 450, IO chiplet 402 is the primary chiplet designated for the security functional domain. IO chiplet 402 thus serves as the root of the directed acyclic graph defined for the security functional domain, and as the aggregation point for security-related information generated within the chiplet network. The directed acyclic graph defined for the security functional domain is rooted at IO chiplet 402 and may, as illustrated in topology view 450, traverse a different set of directed paths through the chiplet network than the directed acyclic graph defined for the system management functional domain. Each non-primary chiplet that participates in the security functional domain forwards security-related information toward IO chiplet 402 along the directed acyclic graph defined for that functional domain, with information being aggregated at intermediate chiplets and forwarded upstream in the manner described above with respect to topology view 400.

The juxtaposition of topology views 400 and 450 in FIG. 4 illustrates that the primary chiplet designated for one functional domain need not be, and in some embodiments is not, the same chiplet as the primary chiplet designated for another functional domain supported by the chiplet network. In the illustrated example, CPU chiplet 401 is the primary chiplet for the system management functional domain but not for the security functional domain, while IO chiplet 402 is the primary chiplet for the security functional domain but not for the system management functional domain. Each of CPU chiplet 401 and IO chiplet 402 may participate as a non-primary chiplet in the functional domain for which the other chiplet is primary, forwarding domain-specific information for that other functional domain toward the other chiplet along the directed acyclic graph defined for that other functional domain.

In some embodiments, domain-specific information for each functional domain may be conveyed among the chiplets along a domain-specific channel distinct from the channels used for other functional domains. As used herein, a "domain-specific channel" for a functional domain refers to a logical communication channel over which domain-specific information for that functional domain is conveyed among the chiplets of a SiP. A domain-specific channel for one functional domain is logically distinct from a domain-specific channel for another functional domain, although domain-specific channels for different functional domains may, in some embodiments, share an underlying physical interconnect. Examples of domain-specific channels include, by way of example and not limitation, a boot channel for the boot domain, a security channel for the security domain, an interrupt channel for the interrupt domain, a functional safety messaging channel for the functional safety domain, a system management channel for the system management domain, a RAS channel for the RAS domain, a debug channel for the debug or test domain, a test channel for the debug or test domain, an address translation channel for the address translation domain, and a system time management channel for the system time management domain.

Selecting different primary chiplets for different functional domains may permit a SiP integrator to designate, for each functional domain, the chiplet best suited to host the primary role for that functional domain. By way of non-limiting example, an IO chiplet that includes a hardware root of trust and external attestation interfaces may be well suited to host the primary role for the security functional domain, while a CPU chiplet that hosts general-purpose processing cores and interfaces with system software may be well suited to host the primary role for the system management functional domain. Designating different chiplets as the primary chiplets for the security and system management functional domains, as illustrated in FIG. 4, may permit each functional domain to be rooted at the chiplet best suited to host it, without requiring any one chiplet of the chiplet network to host the primary role for both functional domains.

Although FIG. 4 illustrates topology views for two functional domains, the chiplet network may support any number of functional domains, including, by way of non-limiting example, a boot domain, a functional safety domain, a RAS domain, an interrupt domain, a debug or test domain, an address translation domain, and a system time management domain, in addition to or in place of the system management and security functional domains illustrated in FIG. 4. For each such functional domain supported by the chiplet network, a corresponding topology view may be defined, with the chiplets participating in that functional domain logically organized as a directed acyclic graph rooted at a primary chiplet designated for that functional domain. The primary chiplet designated for any given functional domain may, in some embodiments, be the same as the primary chiplet designated for one or more other functional domains, or may, in other embodiments, be different from the primary chiplet designated for any other functional domain.

The arrangements shown in topology views 400 and 450 are illustrative and non-limiting. Different embodiments may include different numbers of chiplets, different chiplet types, different connectivity, different functional domains, and different primary chiplet designations. A given chiplet of the chiplet network may participate in any number of functional domains supported by the chiplet network, may serve as the primary chiplet for one or more functional domains, or may participate in one or more functional domains without serving as the primary chiplet for any functional domain.

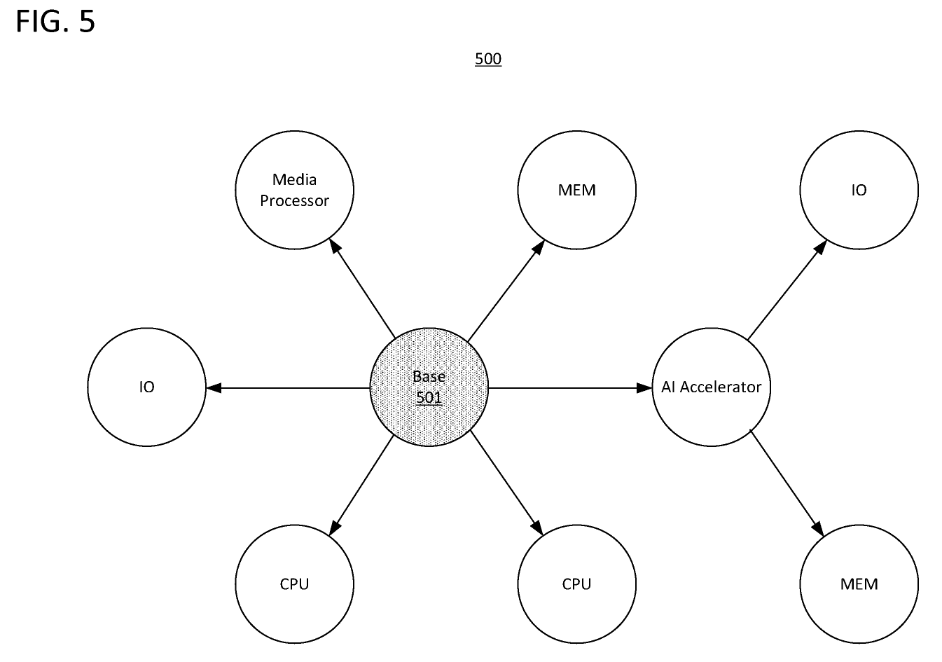

FIG. 5 illustrates topology view 500 of a chiplet network in accordance with specific embodiments of the inventions disclosed herein, in which a single chiplet serves as the primary chiplet for more than one functional domain. The chiplet network represented in FIG. 5 includes a base chiplet 501 at the center of topology view 500 and a plurality of additional chiplets, including, in the illustrated example, a Media Processor chiplet, two MEM chiplets, two IO chiplets, an AI Accelerator chiplet, and two CPU chiplets, each coupled to base chiplet 501. In topology view 500, base chiplet 501 is the primary chiplet designated for both the system management functional domain and the security functional domain.

Because base chiplet 501 is the primary chiplet for both the system management functional domain and the security functional domain, the directed acyclic graph defined for the system management functional domain and the directed acyclic graph defined for the security functional domain are each rooted at base chiplet 501. Each non-primary chiplet that participates in either functional domain forwards domain-specific information for that functional domain toward base chiplet 501 along the directed acyclic graph defined for that functional domain. Although the two directed acyclic graphs are rooted at the same chiplet in topology view 500, the directed acyclic graphs may remain logically distinct, with system management information conveyed along the directed acyclic graph defined for the system management functional domain and security-related information conveyed along the directed acyclic graph defined for the security functional domain. In some embodiments, base chiplet 501 may implement a separate domain-local aggregation entity for each of the system management functional domain and the security functional domain, the entities operating independently of one another at base chiplet 501.

Whereas FIG. 4 illustrated an embodiment in which the primary chiplet designated for one functional domain is a different chiplet than the primary chiplet designated for another functional domain, FIG. 5 illustrates that, in specific embodiments, a single chiplet may be designated as the primary chiplet for two or more functional domains supported by a chiplet network. By way of non-limiting example, base chiplet 501 may be designated as the primary chiplet for the system management functional domain and the security functional domain as illustrated, and may, in some embodiments, be additionally designated as the primary chiplet for one or more further functional domains supported by the chiplet network, such as a boot functional domain, a functional safety functional domain, a RAS functional domain, an interrupt functional domain, a debug or test functional domain, an address translation functional domain, or a system time management domain. In further embodiments, base chiplet 501 may be designated as the primary chiplet for some functional domains supported by the chiplet network while one or more other chiplets of the chiplet network may be designated as the primary chiplet for one or more further functional domains supported by the chiplet network.

Designating a single chiplet of a chiplet network as the primary chiplet for two or more functional domains may, in some embodiments, simplify aggregation of domain-specific information across functional domains, simplify external communication of aggregated information from the chiplet network for two or more functional domains, or both. By way of non-limiting example, where base chiplet 501 implements essential functions of the SiP and is coupled to interfaces suitable for external communication for both the system management functional domain and the security functional domain, designating base chiplet 501 as the primary chiplet for both functional domains may permit external communication for both functional domains to occur through base chiplet 501. The decision whether to designate a single chiplet as the primary chiplet for multiple functional domains, or to designate different chiplets as the primary chiplet for different functional domains as illustrated in FIG. 4, may, in some embodiments, be made by a SiP integrator based on the capabilities of the chiplets, the requirements of the functional domains, and other design considerations relevant to the SiP. Since the topology may be fixed after packaging, no discovery may be required during boot time or run time.

The arrangement shown in topology view 500 is illustrative and non-limiting. Different embodiments may include different numbers of chiplets, different chiplet types, different connectivity, and different primary chiplet designations. A given chiplet of a chiplet network may serve as the primary chiplet for any number of functional domains supported by the chiplet network, including all of the functional domains supported, a strict subset of the functional domains supported, exactly one of the functional domains supported, or none of the functional domains supported.

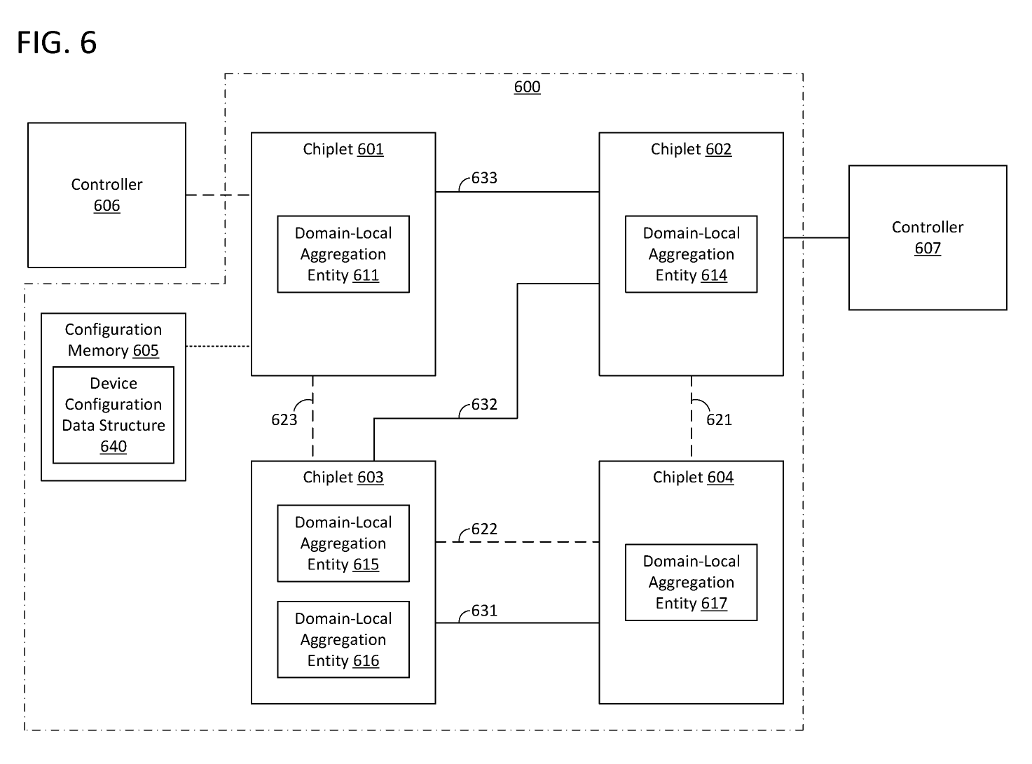

FIG. 6 illustrates network 600 of chiplets collectively supporting a plurality of functional domains in accordance with specific embodiments of the inventions disclosed herein. Network 600 may be a SiP. Network 600 includes chiplets 601, 602, 603, and 604 interconnected by a die-to-die interconnect. Chiplet 601 is the primary chiplet of a first functional domain. Chiplet 602 is the primary chiplet of a second functional domain. In specific embodiments, first primary chiplet 601 may also be the primary chiplet of a third functional domain. The first, second, and third functional domains may refer to distinct functional domains. In specific embodiments, each functional domain may have exactly one designated primary chiplet of the plurality of chiplets. Chiplets 603 and 604 are not designated as the primary chiplet for either of the first functional domain or the second functional domain, and accordingly operate as non-primary chiplets of the first functional domain and the second functional domain. Domain-local aggregation entity 611 of chiplet 601, domain-local aggregation entity 615 of chiplet 603, and domain-local aggregation entity 617 of chiplet 604 may be specific to the first functional domain. Domain-local aggregation entity 614 and domain-local aggregation entity 616 may be specific to the second functional domain.

The functional domains may be, for example, a system management domain, a security domain, a boot domain, a functional safety domain, a RAS domain, an interrupt domain, a debug or test domain, an address translation domain, or a system time management domain. For each functional domain, chiplets 601-604 may be logically organized as a directed acyclic graph rooted at the primary chiplet designated for that functional domain, such that each non-primary chiplet in the directed acyclic graph forwards domain-specific information toward the primary chiplet of that functional domain. Because chiplet 601 is a different chiplet of the plurality of chiplets than chiplet 602, the primary chiplet designated for the first functional domain is a different chiplet of the plurality of chiplets than the primary chiplet designated for the second functional domain. In specific embodiments, the directed acyclic graph for at least one functional domain of the plurality of functional domains may be a directed tree, in which each non-primary chiplet has exactly one immediately upstream chiplet in the directed acyclic graph for that functional domain.

Each chiplet of the plurality of chiplets that participates in a given functional domain may comprise a domain-local aggregation entity configured to aggregate domain-specific information generated within that chiplet with domain-specific information received from any downstream chiplet in the directed acyclic graph for that functional domain. The domain-local aggregation entity may also be configured to forward the aggregated domain-specific information to an immediately upstream chiplet in the directed acyclic graph for that functional domain. As used herein, a "domain-local aggregation entity" of a chiplet for a functional domain refers to logic implemented by the chiplet that is configured to (i) collect domain-specific information generated within the chiplet for that functional domain, (ii) collect domain-specific information for that functional domain received from any downstream chiplet of the chiplet in the DAG for that functional domain, (iii) combine the collected information into aggregated domain-specific information for that functional domain, and (iv) convey the aggregated domain-specific information to the immediately upstream chiplet of the chiplet in the DAG for that functional domain, or, where the chiplet is the primary chiplet for the functional domain, to a destination determined by the primary chiplet. A given chiplet that participates in more than one functional domain may implement a separate domain-local aggregation entity for each functional domain in which the chiplet participates, the entities operating independently of one another along the respective DAGs of their functional domains. If a chiplet does not have any downstream chiplets, the domain-local aggregation entity may organize and send domain-specific information to an upstream component without aggregating its information with downstream chiplets since there are none.

In specific embodiments, configuration memory 605 may store device configuration data structure 640. Device configuration data structure 640 may be a data structure that is established for a SiP and may describe, in a form accessible to software executing on the SiP, configuration information about the SiP. In specific embodiments, the device configuration data structure may specify, for each of one or more functional domains supported by the SiP, an identification of the primary chiplet for the functional domain and a description of the DAG defined for the functional domain. The description of the DAG may include, for each non-primary chiplet participating in that functional domain, one or more immediately upstream chiplets to which domain-specific information is forwarded. Device configuration data structure 640 may identify a single chiplet as the primary chiplet for at least two different functional domains. For example, chiplet 601 may be the primary chiplet for a first functional domain and a third functional domain. The device configuration data structure may be stored in any memory accessible to software executing on the SiP, including, by way of example and not limitation, a non-volatile memory of the SiP, a memory of the primary chiplet of one or more functional domains, or a memory shared among multiple chiplets of the SiP. Chiplets 601-604 may be configured to route domain-specific information for each functional domain in accordance with the DAG specified for that functional domain in device configuration data structure 640, without runtime topology discovery. Device configuration data structure 640 may be established at packaging time and may be accessible to software executing on the SiP of network 600.

By way of non-limiting example, where the first functional domain is a functional safety domain, the domain-local aggregation entity of a given chiplet of network 600, in response to receiving an interrupt from a downstream chiplet for the functional safety domain, may be configured to assert a corresponding output interrupt to the immediately upstream chiplet in the directed acyclic graph for the functional safety domain. In this manner, an interrupt originating at a chiplet that is two or more directed edges removed from the primary chiplet for the functional safety domain may be propagated upstream toward the primary chiplet through one or more intermediate chiplets, with each intermediate chiplet asserting an output interrupt corresponding to the input interrupt it receives.

In specific embodiments, device configuration data structure 640 may specify, for at least one functional domain of the plurality of functional domains (such as a functional safety domain), an interrupt forwarding topology describing connections of interrupts among chiplets participating in that functional domain. The interrupt forwarding topology specified by device configuration data structure 640 may, in some embodiments, describe, for each chiplet that participates in the at least one functional domain, one or more downstream chiplets from which the chiplet is to receive interrupt signals for that functional domain and an immediately upstream chiplet to which the chiplet is to assert corresponding output interrupt signals for that functional domain. The interrupt forwarding topology may, in some embodiments, correspond to the directed acyclic graph specified by device configuration data structure 640 for the same functional domain, such that interrupts for the functional domain propagate upstream toward the primary chiplet for that functional domain along the same directed paths as other domain-specific information for that functional domain. By specifying the interrupt forwarding topology in device configuration data structure 640, the chiplets participating in the functional domain may be configured at packaging time to forward interrupts in accordance with the specified topology, without runtime discovery of the interrupt connections among chiplets.

In specific embodiments, the domain-local aggregation entity of a given chiplet, in response to receiving an interrupt from a downstream chiplet for the functional safety domain, may be configured to assert a corresponding output interrupt to the immediately upstream chiplet in the directed acyclic graph for the functional safety domain. The domain-local aggregation entity of the given chiplet may, in some embodiments, assert the corresponding output interrupt directly through hardware, such that the output interrupt is asserted upon detection of the input interrupt without intervening software action. In other embodiments, the domain-local aggregation entity of the given chiplet may detect the input interrupt and assert the corresponding output interrupt under software control, for example, where software executing on the given chiplet evaluates the input interrupt and determines that an output interrupt is to be asserted. By way of non-limiting example, where chiplet 604 receives an interrupt from a further downstream chiplet of network 600 for the functional safety domain, chiplet 604 may assert a corresponding output interrupt to its immediately upstream chiplet in the directed acyclic graph for the functional safety domain, which in turn may assert a corresponding output interrupt to its own immediately upstream chiplet, and so on, until the input interrupt has been propagated upstream to the primary chiplet for the functional safety domain. The primary chiplet for the functional safety domain, upon receiving an interrupt aggregated through one or more intermediate chiplets in this manner, may, in some embodiments, query the immediately downstream chiplet from which the interrupt was received to determine the source of the interrupt, and may continue to query chiplets along the directed acyclic graph for the functional safety domain until the chiplet at which the interrupt originated has been identified.

For each functional domain, chiplets 601-604 may be configured to route domain-specific information for that functional domain along a domain-specific channel. The domain-specific channels for the first functional domain are channels 621, 622, and 623 (shown as dashed lines in FIG. 6) while the domain-specific channels for the second functional domain are channels 631, 632, and 633 (shown as solid lines). The domain-specific channels for the first functional domain may be logically distinct from the domain-specific channels for the second functional domain, even where channels of either functional domain may, in some embodiments, be carried over shared underlying physical interconnect resources.

Although chiplets 601-604 are interconnected by a common die-to-die interconnect, the directed acyclic graphs defined for different functional domains may follow different directed paths through network 600 and may be rooted at different chiplets. The topology of the first functional domain may have chiplet 601 as the primary, chiplet 603 directly downstream of chiplet 601, chiplet 604 directly downstream of chiplet 603, and chiplet 602 directly downstream of chiplet 604. For the directed acyclic graph defined for the first functional domain, chiplet 602 may forward first-domain-specific information to chiplet 604; chiplet 604 may aggregate that information with its own first-domain-specific information using domain-local aggregation entity 617 and may forward the aggregated information to chiplet 603; and chiplet 603 may aggregate that information with its own first-domain-specific information using domain-local aggregation entity 615 and may forward the aggregated information to chiplet 601, which is the primary chiplet for the first functional domain. Chiplet 604 may receive first-domain-specific information from chiplet 602 via channel 621. Chiplet 603 may receive aggregated first-domain-specific information from chiplet 604 via channel 622.

Chiplet 603 may be configured to send information (including aggregated information) specific to the first functional domain to chiplet 601 along a first directed path. This first directed path may include channel 623. Chiplet 603 may be configured to forward, to chiplet 601, information received from chiplet 604 specific to the first functional domain, aggregated with its first-domain-specific information. The information from chiplet 604 may already be aggregated first-domain-specific information that includes information from chiplet 602. In specific embodiments, because there are not chiplets downstream of chiplet 602 in the first functional domain, chiplet 602 may not include domain-local aggregation entity for the first functional domain. In other embodiments, chiplet 602 may still have a domain-local aggregation entity for the first functional domain but its role may be to organize first-domain-specific information corresponding to chiplet 602 itself rather than aggregate it with downstream first-domain-specific information (since there is none).

The topology of the second functional domain may have chiplet 602 as the primary with chiplets 601 and 603 directly downstream of chiplet 602; chiplet 604 may be directly downstream of chiplet 603. For the directed acyclic graph defined for the second functional domain, chiplet 604 may forward second-domain-specific information to chiplet 603; chiplet 603 may aggregate that information with its own second-domain-specific information using domain-local aggregation entity 616 and may forward the aggregated information to chiplet 602; chiplet 601 may also forward second-domain-specific information directly to chiplet 602. Chiplet 602, the primary chiplet for the second functional domain, accordingly may receive aggregated second-domain-specific information from chiplet 603 and second-domain-specific information from chiplet 601. Chiplet 603 may receive aggregated second-domain-specific information from chiplet 604 via channel 631. Chiplet 602 may receive aggregated second-domain-specific information from chiplet 603 via channel 632. Chiplet 602 may receive aggregated second-domain-specific information from chiplet 601 via channel 633.

Chiplet 603 may be configured to send information specific to the second functional domain to chiplet 602 along a second directed path. The directed path for the second information specific to the second functional domain may be different from the first directed path for the first information specific to the first functional domain. The second directed path may include channel 632. Chiplet 603 may be configured to forward, to chiplet 602, information received from chiplet 604 specific to the second functional domain, aggregated with its second-domain-specific information. In specific embodiments, because there are not chiplets downstream of chiplets 601 and 604 in the second functional domain, chiplets 601 and 604 may not include domain-local aggregation entity for the second functional domain. In other embodiments, chiplets 601 and 604 may each still have a domain-local aggregation entity for the second functional domain but their role may be to organize second-domain-specific information corresponding to the respective chiplet itself rather than aggregate it with downstream second-domain-specific information (since there is none).

In the example of network 600, chiplet 603 participates as a non-primary chiplet in both the first functional domain and the second functional domain, but along different directed paths within the respective directed acyclic graphs of the two functional domains. In the first functional domain, chiplet 603 forwards aggregated information to chiplet 601 along the first directed path. In the second functional domain, chiplet 603 forwards aggregated information to chiplet 602 along the second directed path. The first directed path is different from the second directed path, even though both directed paths originate at chiplet 603 within network 600. Similarly, chiplet 601 serves as the primary chiplet for the first functional domain but forwards second-domain-specific information to chiplet 602 as a non-primary chiplet in the second functional domain, illustrating that a given chiplet may serve as the primary chiplet for one functional domain while operating as a non-primary chiplet for another functional domain.

In specific embodiments, a chiplet that participates in two or more functional domains, such as chiplet 603 of FIG. 6, may be structured to generate, hold, or otherwise source domain-specific information for each of the functional domains in which the chiplet participates. The chiplet may include logic, registers, status indicators, sensors, or other circuitry that, in operation, generates information relevant to a given functional domain. By way of non-limiting example, the chiplet may include error-detection logic that generates information for a RAS functional domain or a functional safety functional domain, may include security-state logic that generates information for a security functional domain, may include power-management or configuration logic that generates information for a system management functional domain, or may include boot-status logic that generates information for a boot functional domain. The information generated, held, or sourced for one functional domain may be logically distinct from the information generated, held, or sourced for another functional domain, even where the same underlying circuitry of the chiplet contributes to information for more than one functional domain. The chiplet may, in some embodiments, implement a separate domain-local aggregation entity for each functional domain in which the chiplet participates, with the domain-local aggregation entity for a given functional domain being configured to operate on the information specific to that functional domain independently of the domain-local aggregation entities for other functional domains in which the chiplet participates.

In specific embodiments, the chiplet is structured to convey the information specific to each functional domain along a path determined by the directed acyclic graph defined for that functional domain, such that information specific to a first functional domain is conveyed toward the primary chiplet designated for the first functional domain and information specific to a second functional domain is conveyed toward the primary chiplet designated for the second functional domain. The chiplet may include one or more die-to-die interface circuits coupled to the die-to-die interconnect, through which the chiplet exchanges information with other chiplets of the network. Routing of information specific to a given functional domain to the appropriate die-to-die interface circuit may be performed by routing logic within the chiplet, by configuration of the domain-local aggregation entity for that functional domain, or by a combination thereof. The routing of information specific to one functional domain to one die-to-die interface circuit, and information specific to another functional domain to a different die-to-die interface circuit, may, in some embodiments, be determined by configuration information specifying, for each functional domain in which the chiplet participates, the immediately upstream chiplet to which information for that functional domain is to be forwarded; the configuration information may, in some embodiments, be derived from device configuration data structure 640 of FIG. 6 and may be applied to the chiplet at packaging time, at boot time, or at another time prior to operation of the chiplet within the SiP. In some embodiments, the chiplet may convey information specific to a first functional domain along a domain-specific channel for the first functional domain and information specific to a second functional domain along a domain-specific channel for the second functional domain that is logically distinct from the domain-specific channel for the first functional domain, with the two domain-specific channels in some embodiments sharing a common underlying die-to-die interconnect resource and in other embodiments being carried over separate underlying die-to-die interconnect resources.

In specific embodiments, the chiplet may receive information specific to a given functional domain from one or more further chiplets that are downstream of the chiplet in the directed acyclic graph for that functional domain, in which case the chiplet may aggregate the information received from the one or more further chiplets with information specific to the functional domain that is generated, held, or sourced within the chiplet itself, and may forward the aggregated information toward the primary chiplet designated for that functional domain along the directed acyclic graph for that functional domain. The chiplet may, in some embodiments, perform such aggregation and forwarding for each functional domain in which it participates, with the aggregation for one functional domain being performed independently of the aggregation for another functional domain. By way of non-limiting example, with reference to FIG. 6, chiplet 603 may aggregate first-domain-specific information received from chiplet 604 with first-domain-specific information generated within chiplet 603 and forward the aggregated first-domain-specific information to chiplet 601 along the directed acyclic graph for the first functional domain, and may concurrently or independently aggregate second-domain-specific information received from chiplet 604 with second-domain-specific information generated within chiplet 603 and forward the aggregated second-domain-specific information to chiplet 602 along the directed acyclic graph for the second functional domain.

In specific embodiments, chiplet 601, the primary chiplet for the first functional domain, may be configured to aggregate domain-specific information for the first functional domain via domain-local aggregation entity 611 and communicate this information to controller 606. The aggregated domain-specific information communicated from chiplet 601 to controller 606 may include information aggregated by chiplet 601 from one or more downstream chiplets in the directed acyclic graph for the first functional domain, including, by way of non-limiting example, information forwarded by chiplet 603 to chiplet 601 along the first directed path that itself includes information aggregated from chiplet 604 and chiplet 602. Controller 606 may be external to network 600 of chiplets, that is, external to the SiP that includes chiplets 601, 602, 603, and 604. By way of non-limiting example, where the first functional domain is a system management domain or a boot domain, controller 606 may be a baseboard management controller; where the first functional domain is a functional safety domain, controller 606 may be a safety microcontroller unit. The particular type of controller 606 may depend on the nature of the first functional domain and the design of the SiP.

In specific embodiments, chiplet 602, the primary chiplet for the second functional domain, may similarly be configured to aggregate information specific to the second functional domain via domain-local aggregation entity 614 and communicate this information to controller 607. The aggregated information specific to the second functional domain communicated from chiplet 602 to controller 607 may include information aggregated by chiplet 602 from one or more downstream chiplets in the directed acyclic graph for the second functional domain, including, by way of non-limiting example, information forwarded by chiplet 603 to chiplet 602 along the second directed path and information forwarded by chiplet 601 to chiplet 602. Controller 607 may be external to the SiP and, in the embodiment illustrated in FIG. 6, is a different controller than controller 606. The first functional domain and the second functional domain may accordingly communicate aggregated domain-specific information externally to different external controllers, with the path between chiplet 601 and controller 606 being independent of the path between chiplet 602 and controller 607, such that no single chiplet of network 600 is required to serve as a common point of egress from the SiP for both the first functional domain and the second functional domain. In specific embodiments, the first functional domain and the second functional domain may instead communicate aggregated domain-specific information to a common controller external to the SiP.

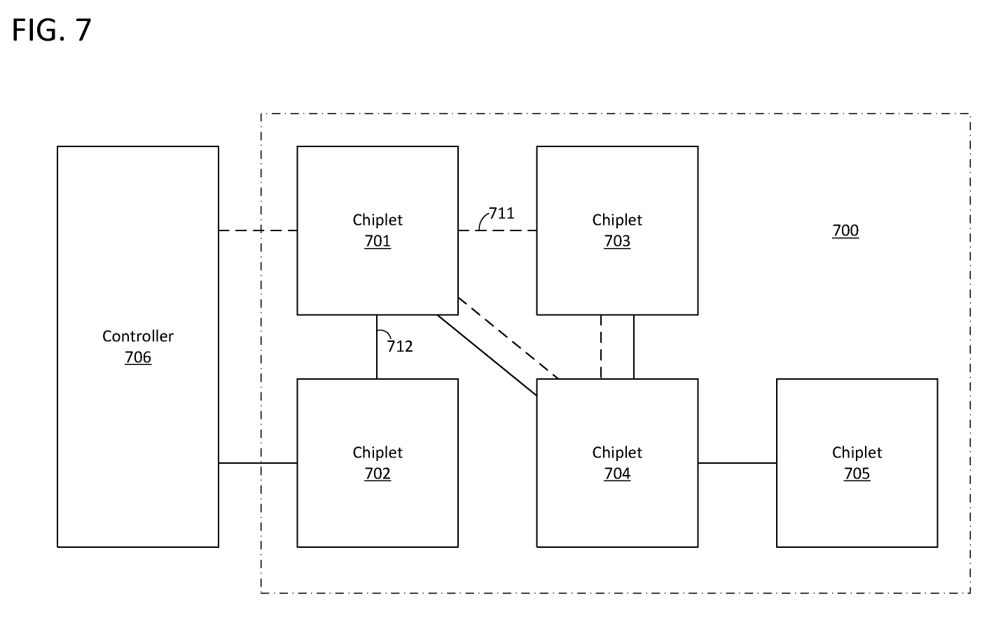

FIG. 7 illustrates network 700 of chiplets collectively supporting a plurality of functional domains where not every chiplet participates in every domain in accordance with specific embodiments of the inventions disclosed herein. Network 700 may be a SiP. Network 700 includes chiplet 701, chiplet 702, chiplet 703, chiplet 704, and chiplet 705, the chiplets being interconnected by a die-to-die interconnect. Chiplet 701 is the primary chiplet designated for a first functional domain; chiplet 702 is the primary chiplet designated for a second functional domain different from the first functional domain. Channels 711 (dashed) may transport domain-specific information of the first functional domain while channels 712 (solid) may transport domain-specific information of the second functional domain.

In some embodiments, a non-primary chiplet of a directed acyclic graph for a given functional domain may have more than one immediately upstream chiplet, with domain-specific information from the non-primary chiplet being forwarded to each of the immediately upstream chiplets. By way of non-limiting example, a chiplet may forward redundant copies of domain-specific information along multiple directed paths within the directed acyclic graph for purposes of high availability, fault tolerance, or load distribution. In such embodiments, the directed acyclic graph for the functional domain may not be a directed tree.

In the example of network 700, chiplet 702 and chiplet 705 participate in the second functional domain but do not participate in the first functional domain; chiplet 701, chiplet 703, and chiplet 704 participate in the first functional domain and in the second functional domain. Accordingly, the directed acyclic graph defined for the first functional domain includes chiplet 701, chiplet 703, and chiplet 704 as nodes, and the directed acyclic graph defined for the second functional domain includes chiplets 701-705 as nodes. A given chiplet of network 700 may, in some embodiments, participate in any subset of the functional domains supported by network 700, including all such functional domains, a strict subset of such functional domains, exactly one such functional domain, or none of such functional domains.

The directed acyclic graph defined for the first functional domain is rooted at first primary chiplet 701. In the illustrated embodiment, chiplet 704 forwards first-domain-specific information to first primary chiplet 701, and chiplet 703 also forwards first-domain-specific information to first primary chiplet 701. Chiplet 704 may, in some embodiments, additionally forward first-domain-specific information to chiplet 703, with chiplet 703 then aggregating the first-domain-specific information received from chiplet 704 with first-domain-specific information of chiplet 703 and forwarding the aggregated first-domain-specific information to first primary chiplet 701. The directed acyclic graph defined for the first functional domain in FIG. 7 is accordingly an example of a directed acyclic graph in which a non-primary chiplet, such as chiplet 704, has more than one immediately upstream chiplet within the directed acyclic graph, distinguishing the directed acyclic graph from a directed tree in which each non-primary chiplet has exactly one immediately upstream chiplet.

The directed acyclic graph defined for the second functional domain is rooted at second primary chiplet 702. In the illustrated embodiment, chiplet 705 forwards second-domain-specific information to chiplet 704, chiplet 703 forwards second-domain-specific information to chiplet 704, chiplet 704 aggregates the second-domain-specific information received from chiplet 705 with second-domain-specific information received from chiplet 703 and with second-domain-specific information of chiplet 704 and forwards the aggregated second-domain-specific information to chiplet 701. Chiplet 701 aggregates the second-domain-specific information received from chiplet 704 with second-domain-specific information of chiplet 701 and forwards the aggregated second-domain-specific information to chiplet 702. Chiplet 701 thus serves as the primary chiplet for the first functional domain while operating as a non-primary chiplet for the second functional domain, illustrating that a given chiplet of network 700 may serve as a primary chiplet for one functional domain and as a non-primary chiplet for another functional domain.

Chiplet 701 may be configured to communicate aggregated domain-specific information for the first functional domain to controller 706, which may be external to network 700 (e.g., external to the associated SiP). Chiplet 702 is configured to communicate aggregated information specific to the second functional domain to the same controller 706. The first functional domain and the second functional domain accordingly communicate aggregated domain-specific information externally to a common external controller, with the path between chiplet 701 and controller 706 and the path between chiplet 702 and controller 706 being independent paths to controller 706. The choice of whether to communicate aggregated domain-specific information for two or more functional domains to different external controllers or to the same external controller, may, in some embodiments, be made by a SiP integrator based on the design of components external to the SiP and other considerations relevant to the SiP.

The arrangement shown in FIG. 7 is illustrative and non-limiting. Different embodiments may include different numbers of chiplets, different chiplet types, different connectivity, different patterns of chiplet participation across functional domains, and different external controller configurations. A given chiplet of a network may, in some embodiments, participate in any number of functional domains supported by the network, may serve as a primary chiplet for one or more functional domains, may operate as a non-primary chiplet for one or more functional domains, or may both serve as a primary chiplet for one or more functional domains and operate as a non-primary chiplet for one or more other functional domains. A network may include more than two functional domains. A chiplet may be the primary chiplet for multiple functional domains. A chiplet may be the primary chiplet for a single functional domain.

The per-functional-domain organization described herein may afford a number of advantages over conventional multi-chiplet architectures in which a single chiplet serves as the root for substantially all system-level functions. Decoupling the primary role on a per-functional-domain basis can permit a SiP integrator to place each functional domain's root at the chiplet best suited to host it — for example, locating a security domain's primary at a chiplet that implements a hardware root of trust, locating a boot domain's primary at a chiplet coupled to non-volatile boot storage, and locating a functional safety domain's primary at a chiplet implementing safety-qualified logic — without requiring any one chiplet to host the root of every functional domain. This in turn may facilitate the assembly of SiPs from chiplets sourced from different vendors, since no single chiplet need be capable of, or responsible for, every system-level function. Establishing the per-domain topologies at packaging time and conveying them to software through a device configuration data structure may further obviate the need for runtime topology discovery, allowing software to determine the primary chiplet, participating chiplets, and information flow for any functional domain by consulting the device configuration data structure. The use of independent external communication paths for different functional domains' primary chiplets may also permit, for example, boot and management information to be conveyed to a baseboard management controller while functional safety information is conveyed to a separate safety microcontroller unit, without either path traversing the other functional domain's primary chiplet.

While the specification has been described in detail with respect to specific embodiments of the invention, it will be appreciated that those skilled in the art, upon attaining an understanding of the foregoing, may readily conceive of alterations to, variations of, and equivalents to these embodiments. Any of the method steps for implementing or designing the systems described herein can be conducted by a processor operating with a computer-readable non-transitory medium storing instructions for those method steps. The computer-readable medium may be memory within a personal user device or a network accessible memory. Although examples in the disclosure were generally directed to a directed acyclic graph having two functional domains, any quantity of functional domains may be supported by a chiplet network. Similarly, although examples in the disclosure were generally directed to chiplet systems, other multi-die integrated circuit systems may be used. These and other modifications and variations to the present invention may be practiced by those skilled in the art, without departing from the scope of the present invention, which is more particularly set forth in the appended claims.

What is claimed is:

1. A network of chiplets comprising:
a plurality of chiplets interconnected by a die-to-die interconnect, the plurality of chiplets collectively supporting a plurality of functional domains, the functional domains comprising at least two of: a system management domain, a security domain, a boot domain, a functional safety domain, a reliability-availability-serviceability domain, an interrupt domain, a debug or test domain, an address translation domain, and a system time management domain;
wherein, for each functional domain of the plurality of functional domains, the plurality of chiplets is logically organized as a directed acyclic graph rooted at a primary chiplet designated for that functional domain, such that each non-primary chiplet in the directed acyclic graph forwards domain-specific information toward the primary chiplet of that functional domain; and
wherein a first primary chiplet designated for a first functional domain of the plurality of functional domains is a different chiplet of the plurality of chiplets than a second primary chiplet designated for a second functional domain of the plurality of functional domains.

2. The network of claim 1, wherein each chiplet of the plurality of chiplets that participates in a given functional domain comprises a domain-local aggregation entity configured to:
aggregate domain-specific information generated within that chiplet with domain-specific information received from any downstream chiplet in the directed acyclic graph for that functional domain; and
forward the aggregated domain-specific information to an immediately upstream chiplet in the directed acyclic graph for that functional domain.

3. The network of claim 2, wherein:
the plurality of functional domains comprise the functional safety domain; and
the domain-local aggregation entity of a given chiplet, in response to receiving an interrupt from a downstream chiplet for the functional safety domain, is configured to assert a corresponding output interrupt to the immediately upstream chiplet in the directed acyclic graph for the functional safety domain.

4. The network of claim 1, wherein the directed acyclic graph for at least one functional domain of the plurality of functional domains is a directed tree.

5. The network of claim 1, wherein the first primary chiplet designated for the first functional domain is also designated for at least one other functional domain of the plurality of functional domains.

6. The network of claim 1, wherein the first primary chiplet is configured to communicate aggregated domain-specific information for the first functional domain to a controller external to the network of chiplets.

7. The network of claim 1, wherein, for each functional domain of the plurality of functional domains, the plurality of chiplets is configured to route domain-specific information for that functional domain along a domain-specific channel.

8. The network of claim 1, wherein each functional domain of the plurality of functional domains has exactly one designated primary chiplet of the plurality of chiplets.

9. The network of claim 1, wherein the primary chiplet designated for at least one functional domain of the plurality of functional domains is configured to send domain-specific information for that functional domain toward at least one non-primary chiplet of the directed acyclic graph defined for that functional domain.

10. The network of claim 1, wherein the directed acyclic graph defined for at least one functional domain of the plurality of functional domains includes a non-primary chiplet that has two or more immediately upstream chiplets in the directed acyclic graph for that functional domain, and the non-primary chiplet is configured to forward domain-specific information for that functional domain to each of the two or more immediately upstream chiplets.

11. A system-in-package comprising:
a plurality of chiplets interconnected by a die-to-die interconnect and supporting a plurality of functional domains; and
a configuration memory storing a device configuration data structure, the device configuration data structure specifying, for each functional domain of the plurality of functional domains:
an identification of a primary chiplet, from the plurality of chiplets, for that functional domain; and
a directed acyclic graph rooted at the primary chiplet and describing, for each non-primary chiplet participating in that functional domain, an immediately upstream chiplet to which domain-specific information is forwarded;
wherein the device configuration data structure identifies different primary chiplets for at least two different functional domains of the plurality of functional domains.

12. The system-in-package of claim 11, wherein the plurality of chiplets is configured to route domain-specific information for each functional domain in accordance with the directed acyclic graph specified for that functional domain in the device configuration data structure, without runtime topology discovery.

13. The system-in-package of claim 11, wherein the device configuration data structure is established at packaging time and accessible to software executing on the system-in-package.

14. The system-in-package of claim 11, wherein the directed acyclic graph specified for at least one functional domain of the plurality of functional domains is a directed tree.

15. The system-in-package of claim 11, wherein a single chiplet of the plurality of chiplets is identified by the device configuration data structure as the primary chiplet for at least two different functional domains of the plurality of functional domains.

16. The system-in-package of claim 11, wherein the directed acyclic graph specified for at least one functional domain of the plurality of functional domains describes, for at least one non-primary chiplet participating in that functional domain, two or more immediately upstream chiplets to which domain-specific information is forwarded.

17. The system-in-package of claim 11, wherein the device configuration data structure further specifies, for at least one functional domain of the plurality of functional domains, an interrupt forwarding topology describing connections of interrupts among chiplets participating in that functional domain.

18. The system-in-package of claim 17, wherein the interrupt forwarding topology specified for the at least one functional domain follows the same directed paths as the directed acyclic graph specified for the at least one functional domain in the device configuration data structure.

19. The system-in-package of claim 17, wherein the at least one functional domain for which the interrupt forwarding topology is specified is a functional safety functional domain.

20. A system-in-package comprising:
a first primary chiplet for a first functional domain;
a second primary chiplet for a second functional domain, wherein the second primary chiplet is different than the first primary chiplet and the second functional domain is different than the first functional domain; and
a third chiplet configured to send first information specific to the first functional domain to the first primary chiplet and to send second information specific to the second functional domain to the second primary chiplet.

21. The system-in-package of claim 20, wherein the third chiplet is configured to send the first information to the first primary chiplet along a first directed path and to send the second information to the second primary chiplet along a second directed path different from the first directed path.

22. The system-in-package of claim 20, further comprising a fourth chiplet, wherein:
the third chiplet is configured to forward, to the first primary chiplet, third information received from the fourth chiplet specific to the first functional domain, aggregated with the first information specific to the first functional domain; and
the third chiplet is configured to forward, to the second primary chiplet, fourth information received from the fourth chiplet specific to the second functional domain, aggregated with the second information.

23. The system-in-package of claim 20, wherein the first functional domain and the second functional domain are each selected from the group consisting of: a system management domain, a security domain, a boot domain, a functional safety domain, a reliability-availability-serviceability domain, an interrupt domain, a debug or test domain, an address translation domain, and a system time management domain.

24. The system-in-package of claim 20, wherein:
the first primary chiplet is configured to communicate aggregated information specific to the first functional domain to a first controller external to the system-in-package; and
the second primary chiplet is configured to communicate aggregated information specific to the second functional domain to a second controller external to the system-in-package that is different than the first controller.

25. The system-in-package of claim 20, wherein:
the first primary chiplet is configured to communicate aggregated information specific to the first functional domain to a controller external to the system-in-package; and
the second primary chiplet is configured to communicate aggregated information specific to the second functional domain to the controller.
